(19) United States
(12) Patent Application Publication
(10) Pub. No.: US 2015/0284625 A1
(43) Pub. Date: Oct. 8, 2015

(54) COMPOSITION AND METHOD FOR TREATING SUBTERRANEAN FORMATIONS USING A GEL COMPOSITION CONTAINING NANOPARTICLES

(71) Applicant: BAKER HUGHES INCORPORATED, Houston, TX (US)

(72) Inventors: SCOTT JOSEPH SILVEIRA, HOUSTON, TX (US); CHARLES DAVID ARMSTRONG, TOMBALL, TX (US)

(73) Assignee: BAKER HUGHES INCORPORATED

(21) Appl. No.: 14/675,191

(22) Filed: Mar. 31, 2015

Related U.S. Application Data
(60) Provisional application No. 61/975,427, filed on Apr. 4, 2014.

(51) Int. Cl. C09K 8/68; E21B 43/26

(52) U.S. Cl. CPC C09K 8/685; E21B 43/26; C09K 2208/10

(57) ABSTRACT

A gel composition for use in a subterranean formation is provided. The gel composition comprises an aqueous fluid, a cross-linkable polymer soluble in the aqueous fluid, a cross-linking agent and nanoparticles.

### RELATED APPLICATIONS

This application claims the benefit, and priority benefit, of U.S. Provisional Patent Application Ser. No. 61/975,427, filed Apr. 4, 2014, the contents of which are incorporated by reference herein in their entirety.

### BACKGROUND

1. Field of the Invention

The presently disclosed subject matter relates to a gel composition containing nanoparticles and the use of the gel composition in oil and gas related applications.

2. Description of Art

Hydraulic fracturing is used to create fractures and increase connectivity between existing pores and natural channels in subterranean formations. A high-viscosity fracturing fluid containing proppant is pumped into the subterranean formation at sufficient pressure to fracture the formation. A proppant is added to the fracturing fluid and carried into the fracture. Once the proppant is in place, chemical breakers are used to reduce the fluid's viscosity. This allows the proppant to settle into the fracture. The fracture continues to grow as more fluid and proppant are introduced into the formation. The reduction in fluid viscosity along with fluid leak-off from the created fracture into permeable areas of the formation allows the fracture to close on the proppant. The proppant holds the fracture open and provides a highly conductive pathway for flow of hydrocarbons and/or other formation fluids, thus increasing the rate at which fluids can be produced by the formation.

Guar is often used to increase the viscosity of fracturing fluids. Higher viscosity fracturing fluids are often utilized in order to obtain the desired fracture width. Due to the costs associated with guar, it is not economical to obtain the desired high viscosity by simply increasing the guar concentration. As a naturally occurring material, guar is a limited natural resource, the demand for which has increased greatly in recent years. In addition to significant supply limitations, guar-based fracturing fluids are also limited by other significant disadvantages, including but not limited to, the hydration limitations of the guar polymer, formation damage, i.e., undesirable coating of proppant materials and/or formation surfaces with the guar polymer or residue, and instability of the guar polymer at elevated temperatures in certain types of fracturing applications.

It is therefore desirable to provide a means for reducing the concentration of guar needed to produce the desired viscosity for hydraulic fracturing.

### SUMMARY

In certain illustrative embodiments, a gel composition for use in a subterranean formation is provided. The gel composition can include an aqueous fluid, a cross-linkable polymer soluble in the aqueous fluid, a cross-linking agent and nanoparticles. In certain illustrative embodiments, the nanoparticles can comprise synthetic clays such as laponite. In certain illustrative embodiments, the nanoparticles can be one or more materials from the group consisting of hectorite, montmorillonite and beidellite. The gel composition can be a guar polymer slurry.

In another aspect, a method of treating a subterranean formation is provided. A gel composition can be provided which includes an aqueous fluid, a cross-linkable polymer soluble in the aqueous fluid and a cross-linking agent. Nanoparticles can be added to the gel composition. The gel composition can be injected into the subterranean formation. The gel composition can be cross-linked. In certain illustrative embodiments, the nanoparticles can comprise synthetic clays such as laponite. In certain illustrative embodiments, the nanoparticles can be one or more materials from the group consisting of hectorite, montmorillonite and beidellite.

In another aspect, an uncrosslinked gel system or polymer or viscous fluid composition for use in a subterranean formation is provided. The uncrosslinked gel system or polymer or viscous fluid composition can include an aqueous fluid, a polymer or viscous fluid soluble in the aqueous fluid, and nanoparticles. In certain illustrative embodiments, the nanoparticles can comprise synthetic clays such as laoponite. In certain illustrative embodiments, the nanoparticles can be one or more materials from the group consisting of hectorite, montmorillonite and beidellite.

According to the illustrative embodiments disclosed herein, the addition of nanoparticles to the gel composition used for hydraulic fracturing can effectively reduce the concentration of guar needed to produce the desired viscosity for hydraulic fracturing because of the nanoparticles' ability to generate viscosity. An additional benefit of guar concentration reduction would be the reduction of filter cake damage, which would subsequently reduce formation damage.

### BRIEF DESCRIPTION OF THE DRAWINGS

FIG. 1 is a graph showing viscosity vs. time for various gel compositions containing guar and nanoparticles in an illustrative embodiment.

FIG. 2 is a graph showing viscosity vs. time (normalized) for various gel compositions containing guar and nanoparticles in an illustrative embodiment.

FIG. 3 is a graph showing viscosity vs. time for various gel compositions containing guar and nanoparticles in an illustrative embodiment.

While certain preferred illustrative embodiments will be described herein, it will be understood that this description is not intended to limit the subject matter to those embodiments. On the contrary, it is intended to cover all alternatives, modifications, and equivalents, as may be included within the spirit and scope of the subject matter as defined by the appended claims

### DETAILED DESCRIPTION

Disclosed herein is a gel composition for use in treating subterranean formations. In certain illustrative embodiments, the gel composition can comprise an aqueous fluid, a cross-linkable polymer that is soluble in the aqueous fluid, and a cross-linking agent. The gel composition can be injected into the subterranean formation and allowed to penetrate the formation. Preferably, the gel composition can be used in fracturing operations to create fractures and increase connectivity between existing pores and natural channels in the formation.

In certain illustrative embodiments, the aqueous fluid can be water or a mixture of water and one or more organic solvents such as alcohols, glycols, and/or hydrocarbons.

In certain illustrative embodiments, the cross-linkable polymer can be a hydrophilic polymer that is generally soluble in the aqueous fluid and is capable of being cross-linked in solution so that the polymer interconnects to form a semi-solid gel. Examples of these polymers are well known to those skilled in the art. Those that can be utilized according to the presently disclosed subject matter can include polyacrylamide and partially hydrolyzed polyacrylamide polymers, polymers and copolymers of acrylic acid and acrylamide, cellulose ethers such as ethyl cellulose, methyl cellulose and cellulose derivatives, diutan, xanthan and xanthan derivatives, and substituted and unsubstituted galactomannans including guar gum and guar derivatives. Other suitable cross-linkable polymers may also be used in forming the gel composition of the presently disclosed subject matter, and are well known and will be readily apparent to those skilled in the art.

Various cross-linking agents are also well known to those skilled in the art. Examples of suitable cross-linking agents according to the presently disclosed subject matter can include the salts or complexes of the multivalent metals such as chromium, zirconium, titanium and aluminum. These cross-linking agents bond ionically with the polymers to form the cross-linked molecule. Other suitable cross-linking agents may be used in forming the gel composition of the presently disclosed subject matter, and are well known and will be readily apparent to those skilled in the art. Some of these include formaldehyde releasers such as hexamethylene tetramine or trioxane combined with phenol-based derivatives such as catechol, hydroquinone, or pyrogallol. The amount of cross-linking agent used will typically vary depending upon the type of polymer and the degree of cross-linking desired. Alternatively, in certain illustrative embodiments, the gel composition will not contain any cross-linking agents. Delaying agents and other additives may also be used with the gel composition.

The gel composition of the presently disclosed subject matter can further comprise nanoparticles. In an illustrative embodiment, the nanoparticles can comprise one or more materials from the group consisting of hectorite, montmorillonite and beidellite. For example, the nanoparticles can comprise synthetic clays. The nanoparticles can act to increase the viscosity of the gel composition and reduce the concentration of cross-linkable polymer in the composition.

In certain illustrative embodiments, the nanoparticles comprise the synthetic clay known as Laponite, which is commercially available from BYK Additives Inc. (formerly Rockwood Additives). Laponite is a synthetic clay that can be used as a rheology modifier in aqueous solutions to impart thixotropic, shear sensitive viscosity and improve stability and syneresis control in certain commercial applications. In certain illustrative embodiments, the Laponite can be Laponite RD.

In certain illustrative embodiments, the gel composition of the presently disclosed subject matter can further comprise macromolecules such as hectorite, montmorillonite and beidellite. The macromolecules can be large molecular weight polymers containing ethylene oxide and propylene oxide, i.e. Pluronic F-127 from BASF Inc.

The nanoparticles should be present in the gel composition of the presently disclosed subject matter in an amount sufficient to provide the desired properties. The utilized amounts would effectively reduce the concentration of polymer that is used in the gel composition.

Other additives suitable for use in operations in subterranean formations also may be added to the gel composition. These other additives can include, but are not limited to, biocide, scale inhibitor, corrosion inhibitor, paraffin inhibitor, asphaletene inhibitor, iron control and other commonly used oilfield chemicals and combinations thereof. A person having ordinary skill in the art, with the benefit of this disclosure, will know the type and amount of additive useful for a particular application and desired result.

Various methods of treating subterranean formations using gel compositions containing nanoparticles are also disclosed herein. For example, disclosed herein is a method of treating a subterranean formation. A gel composition is provided comprising an aqueous fluid, a cross-linkable polymer that is soluble in the aqueous fluid, and a cross-linking agent. Nanoparticles can be added to the gel composition. In certain illustrative embodiments, the nanoparticles can comprise synthetic clays. In certain illustrative embodiments, the nanoparticles comprise one or more materials from the group consisting of hectorite, montmorillonite and beidellite. The gel composition can be injected into the openings in the subterranean formation and cross-linked. The nanoparticles do not interfere with the cross-linking process and do not adversely affect the ability of the gel composition to be injected into the openings.

The gel composition and related methods described herein have a number of advantages. For example, the addition of nanoparticles to the gel composition can effectively reduce the concentration of guar needed to produce the desired viscosity for hydraulic fracturing because of the nanoparticles' ability to generate viscosity. Further, the size of the filter cake can be reduced which would subsequently reduce formation damage. Also, the gel composition is readily recoverable from the subterranean formation.

To facilitate a better understanding of the presently disclosed subject matter, the following examples of certain aspects of certain embodiments are given. In no way should the following examples be read to limit, or define, the scope of the presently disclosed subject matter.

### EXAMPLES

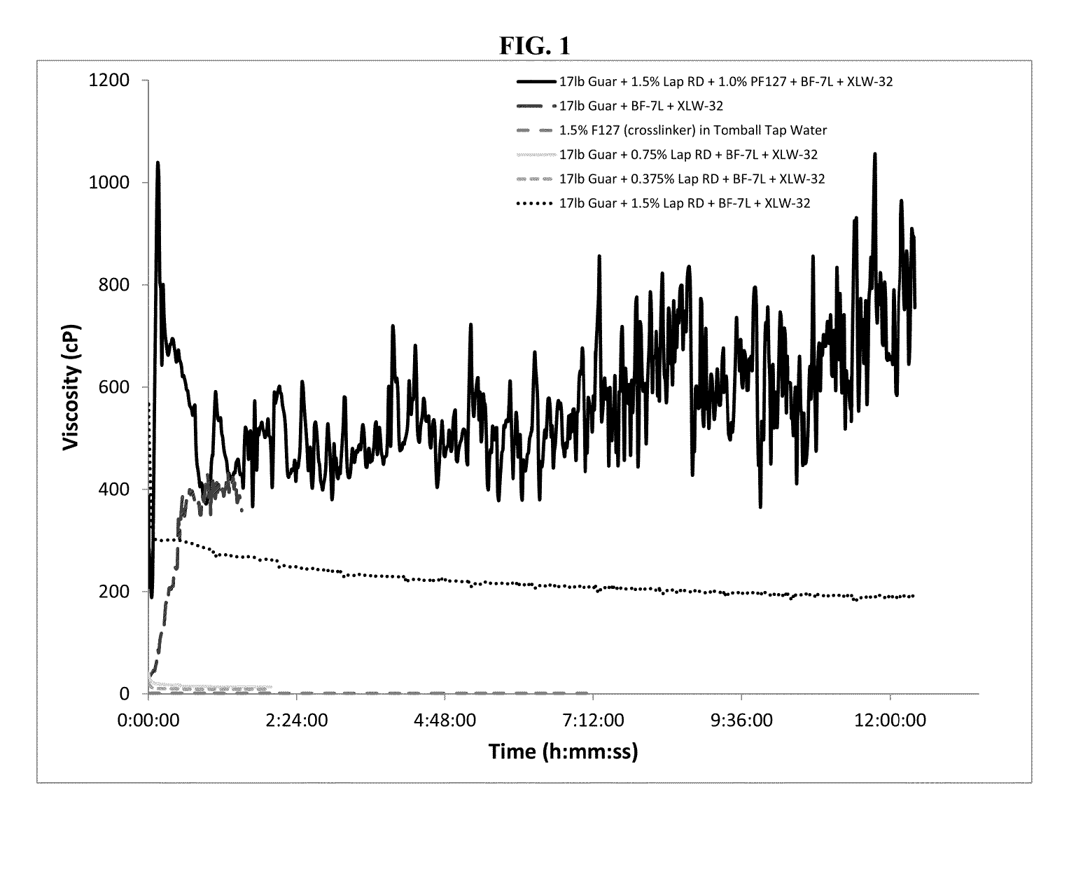

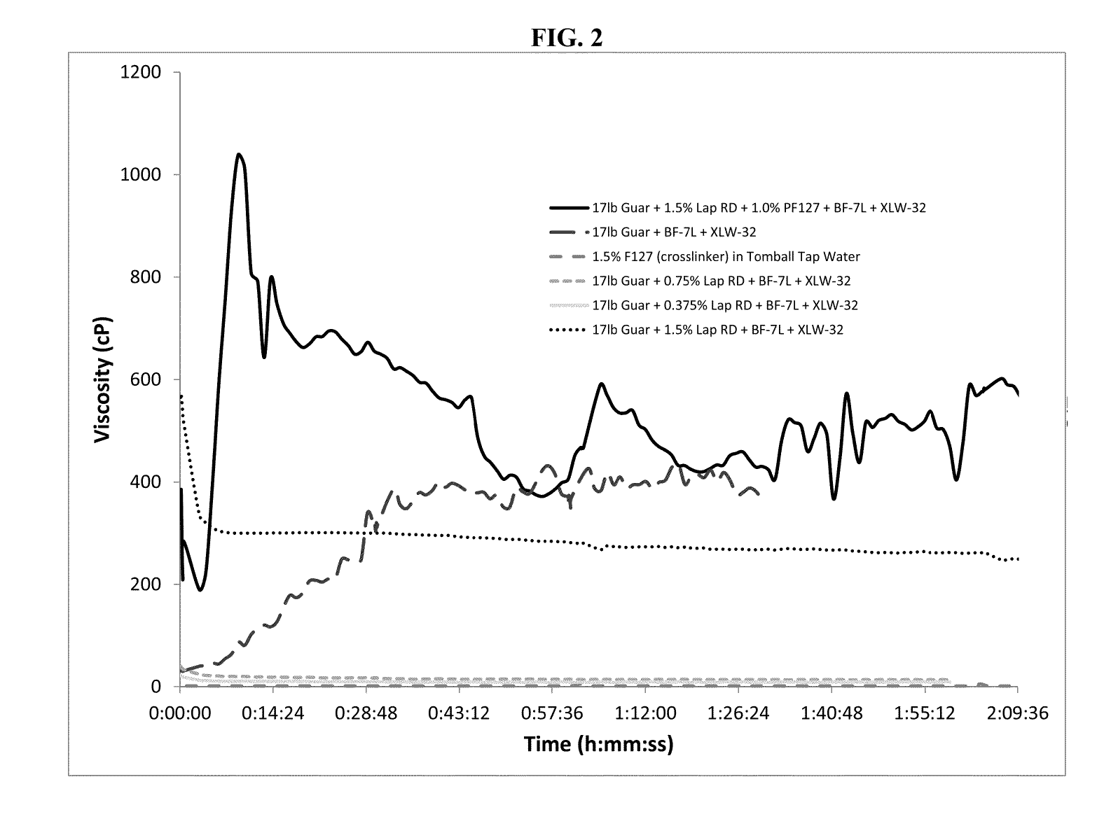

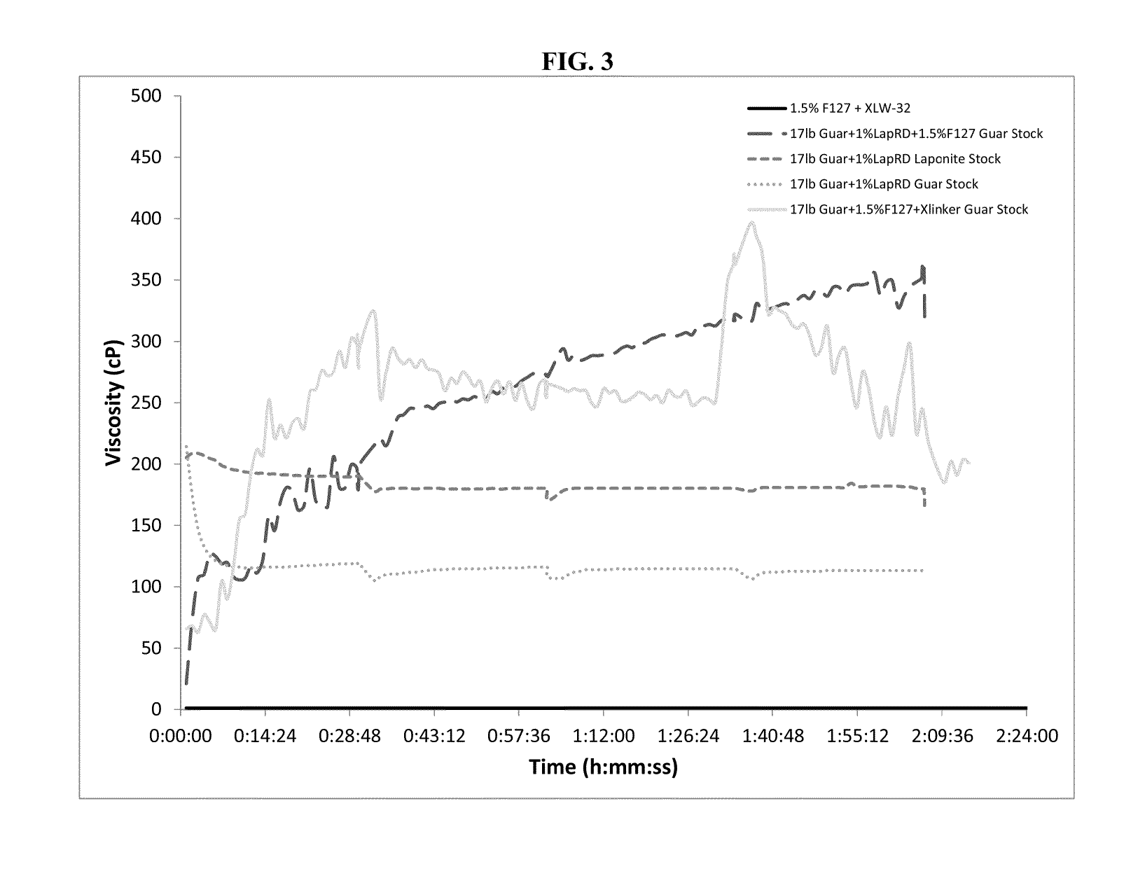

Nanoparticles were added to a gel composition to reduce the concentration of guar polymer in the composition. Base fluids of guar stock, laponite stock and nanoparticle stock were tested. The term “stock” refers to a material being hydrated in an aqueous solution after which other components were added. Results are shown in FIGS. 1-3 hereto, which generally indicate that viscosity was increased.

In certain illustrative embodiments, the gel composition can be used as a loss circulation material or combined with drilling fluids. In certain aspects, the nanoparticles may require sufficient hydration time in the form of two or more separate slurries. When the technology is ready to be deployed, the various slurries and mobile phase can be homogenized and injected down hole as a fracturing fluid.

While the disclosed subject matter has been described in detail in connection with a number of embodiments, it is not limited to such disclosed embodiments. Rather, the disclosed subject matter can be modified to incorporate any number of variations, alterations, substitutions or equivalent arrangements not heretofore described, but which are commensurate with the scope of the disclosed subject matter. Additionally, while various embodiments of the disclosed subject matter have been described, it is to be understood that aspects of the disclosed subject matter may include only some of the described embodiments. Accordingly, the disclosed subject matter is not to be seen as limited by the foregoing description, but is only limited by the scope of the appended claims.

What is claimed is:

1. A gel composition for use in a subterranean formation, the gel composition comprising:
an aqueous fluid;
a cross-linkable polymer soluble in the aqueous fluid;
a cross-linking agent; and
nanoparticles.

2. The gel composition of claim 1, wherein the nanoparticles comprise synthetic clays.

3. The gel composition of claim 3, wherein the synthetic clays comprise laponite.

4. The gel composition of claim 1, wherein the nanoparticles comprise one or more materials from the group consisting of hectorite, montmorillonite and beidellite.

5. A method of treating a subterranean formation, the method comprising:
providing a gel composition comprising an aqueous fluid, a cross-linkable polymer soluble in the aqueous fluid and a cross-linking agent;
adding nanoparticles to the gel composition;
injecting the gel composition into the opening in the subterranean formation;
cross-linking the gel composition; and
treating the subterranean formation with the gel composition.

6. The gel composition of claim 5, wherein the nanoparticles comprise synthetic clays.

7. The gel composition of claim 6, wherein the synthetic clays comprise laponite.

8. The gel composition of claim 5, wherein the nanoparticles comprise one or more materials from the group consisting of hectorite, montmorillonite and beidellite.

9. An uncrosslinked gel system or polymer or viscous fluid composition for use in a subterranean formation, the uncrosslinked gel system or polymer or viscous fluid composition comprising:
an aqueous fluid;
a polymer or viscous fluid soluble in the aqueous fluid; and
nanoparticles.

10. The gel composition of claim 9, wherein the nanoparticles comprise synthetic clays.

11. The gel composition of claim 10, wherein the synthetic clays comprise laponite.

12. The gel composition of claim 9, wherein the nanoparticles comprise one or more materials from the group consisting of hectorite, montmorillonite and beidellite.
